(19) United States
(12) Patent Application Publication
(10) Pub. No.: US 2016/0230920 A1
(43) Pub. Date: Aug. 11, 2016

(54) Hay Bale Support

(71) Applicant: Robert Michael Taylor, Perkins, OK (US)

(72) Inventor: Robert Michael Taylor, Perkins, OK (US)

(21) Appl. No.: 15/041,481

(22) Filed: Feb. 11, 2016

Related U.S. Application Data
(60) Provisional application No. 62/114,615, filed on Feb. 11, 2015.

(51) Int. Cl. F16M 11/00

(52) U.S. Cl. CPC F16M 11/00

(57) ABSTRACT

Round bales of hay are often stored outside on the ground and exposed to the weather. The design of the bale is such that is does a reasonable job of minimizing water infusion into the bale due to rain or melting snow on the outer surface of the bale. The primary degradation mechanism for the hay bale is moisture at the interface between the bale and the ground. The present invention provides for a cost effective means of elevating the bale above the ground surface thereby eliminating moisture uptake and degradation of the bottom surface of the bale. Eliminating degradation due to ground contact offers a means of longer viable storage periods for round hay bales.

### FIELD OF THE EMBODIMENTS

The field of the embodiments relates to a means for supporting round hay bales in a manner that prohibits contact with the ground thereby eliminating ground rot. The bale support is in the form of a stand that cradles the bale offering a stable resting place and allowing air to flow under the bale to promote a dry bale surface.

### BACKGROUND OF THE EMBODIMENTS

Hay for use as livestock feed is commonly baled in the form of large round bales. Round hay bales are popular due to their ability to shed water over their surface allowing them to be stored outside with low waste to all surfaces that are not in contact with the ground. Research shows that round bales stored outside on a surface that prohibits water from wicking into the bottom surface of the bale experience total loses of only a few percent for a year of storage. The surfaces most commonly used in these research studies include gravel pads and used pallets. The same research studies show that bales left in contact with the ground suffer significant hay loss due to rotting as a result of moisture wicking into the bales lower surface. The losses reported in the research can be as high as 40% for hay stored in an area or high heat and plentiful rainfall. The use of a gravel pad to prohibit hay loss presents a maintenance problem. Over time grass growth and dirt and debris fill the gravel bed porosity limiting its ability to efficiently wick water away from the bale surface. The use of pallets to maintain ground clearance for the bale requires the user to place a pallet in position for stacking after the placement of each individual bale since the pallets are too wide to straddle with most vehicles used for moving the hay. The reverse problem exists when feeding the hay. The pallet placement issue adds significant time to the storage or feeding process. The round bale support stand proposed here offers a convenient means of storing and recovering hay bales for feeding. The stand is narrow enough to allow most hay moving equipment to straddle the stand allowing the user to place all of the required stands in place before the stacking operation commences and the stands can be left in place if desired as the hay is fed. The stands are manufactured to accommodate a single bale and allow bales to be tightly stacked end to end.

### SUMMARY OF THE EMBODIMENTS

The device offers stable support for a round bale of hay and prohibits contact with the ground.

### BRIEF DESCRIPTION OF THE DRAWINGS

FIG. 1A is a front view of a round extruded embodiment of the round bale support stand; FIG. 1B is a top view of a round extruded embodiment of the round bale support stand.

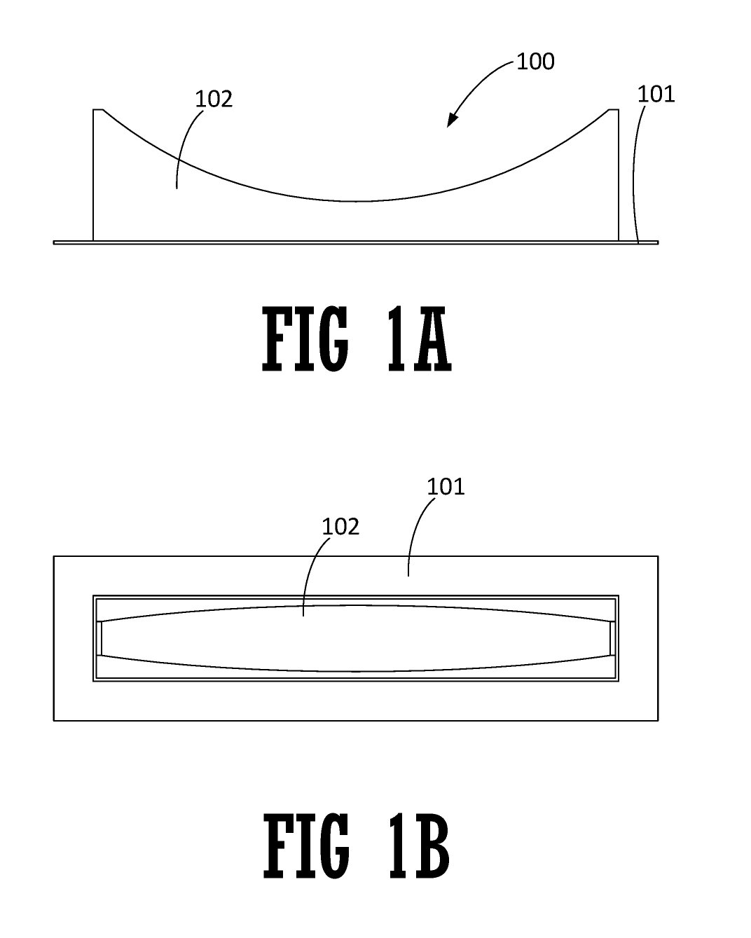

FIG. 2A is a bottom view of a round extruded embodiment of the round bale support stand; FIG. 2B is a side view of a round extruded embodiment of the round bale support stand.

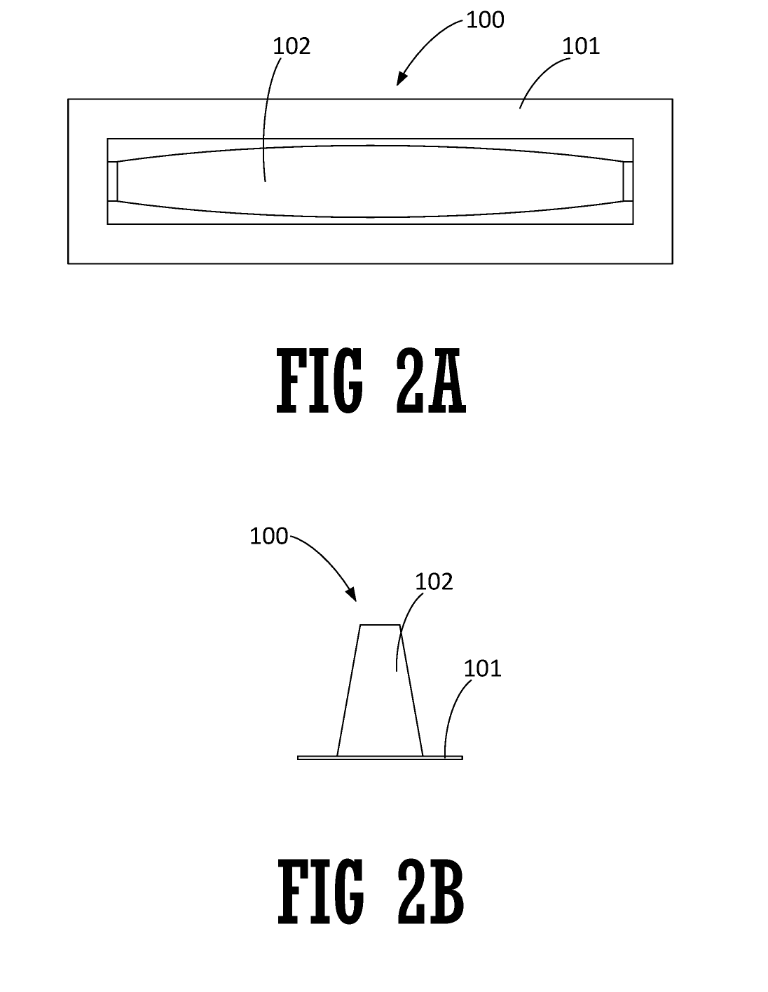

FIG. 3 is an isometric view of a round extruded embodiment of the round bale support stand.

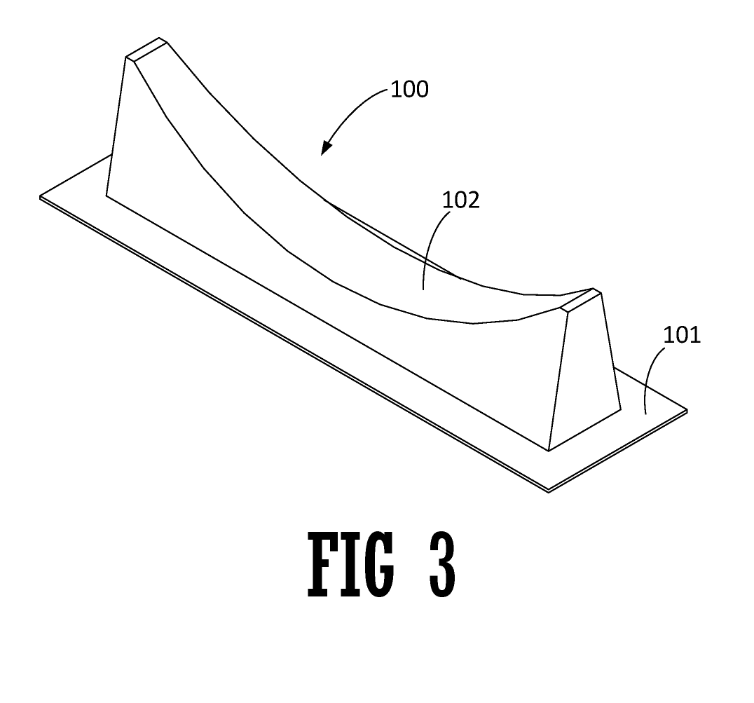

FIG. 4A is a front view of a v-shaped extruded embodiment of the round bale support stand; FIG. 4B is a top view of a v-shaped extruded embodiment of the round bale support stand.

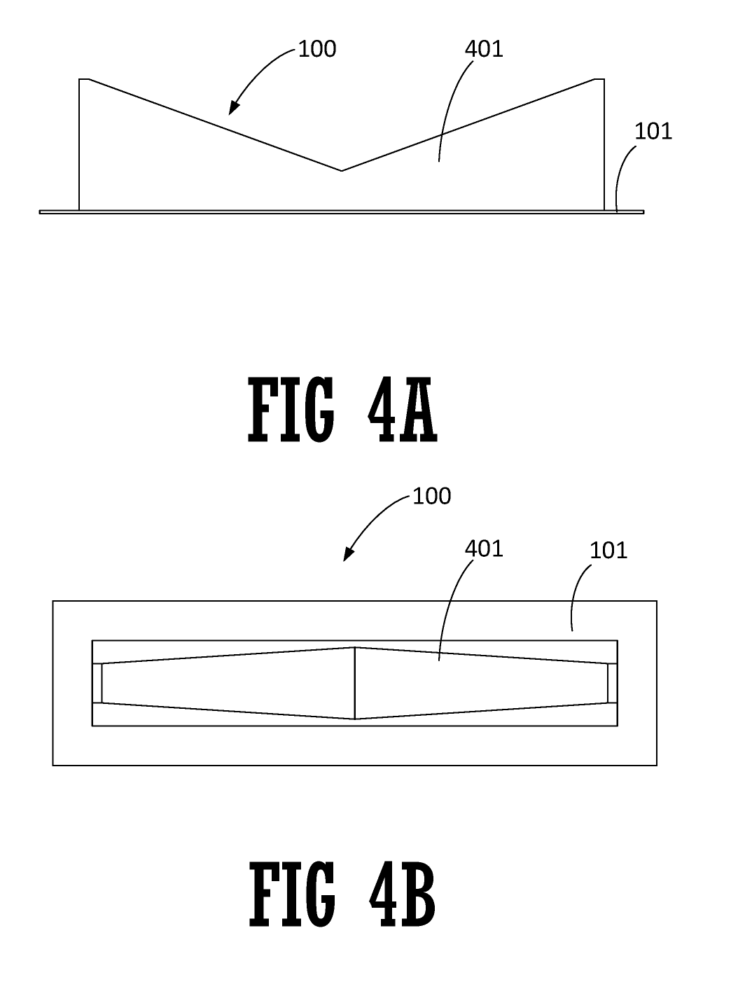

FIG. 5A is a bottom view of a v-shaped extruded embodiment of the round bale support stand; FIG. 5B is a side view of a v-shaped extruded embodiment of the round bale support stand.

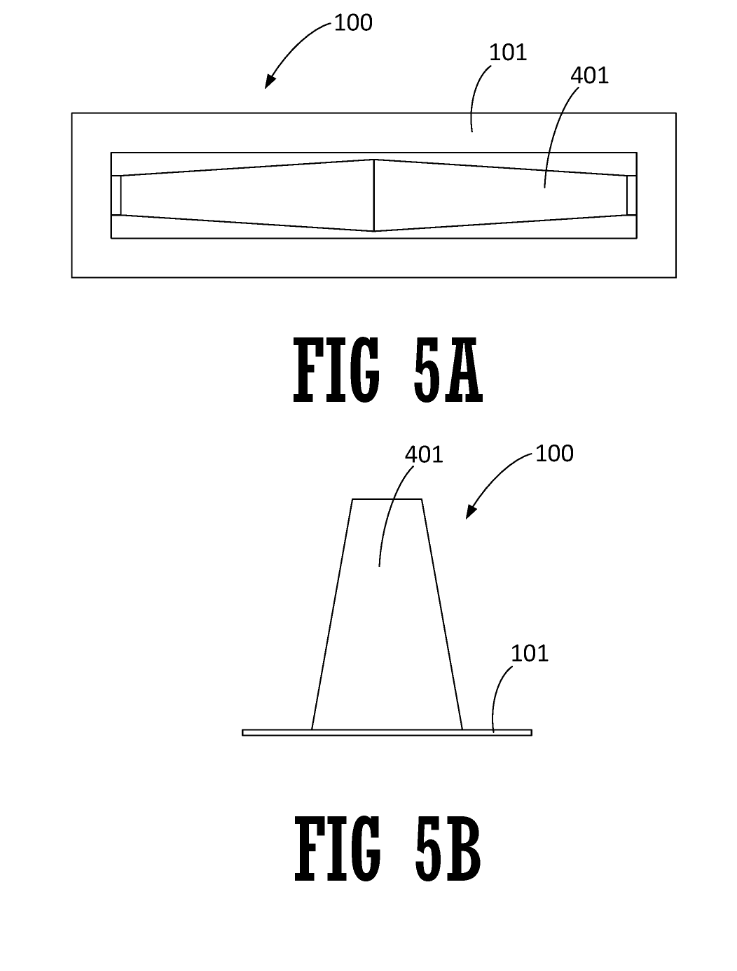

FIG. 6 is an isometric view of a v-shaped extruded embodiment of the round bale support stand.

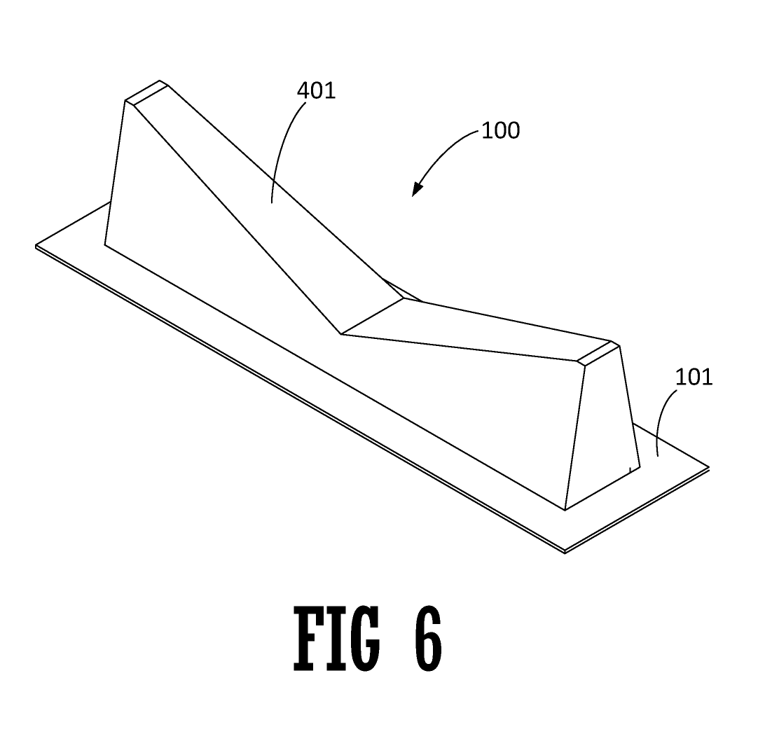

FIG. 7A is a front view of a block support embodiment of the round bale support stand; FIG. 7B is a top view of a block support embodiment of the round bale support stand.

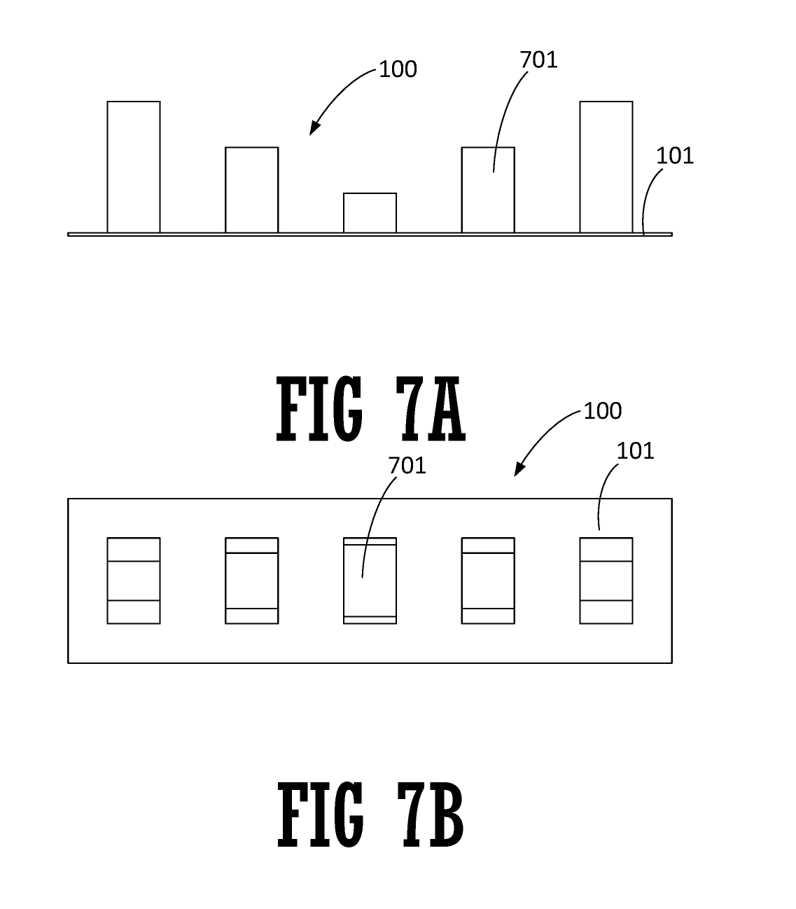

FIG. 8A is a bottom view of a block support embodiment of the round bale support stand; FIG. 8B is a side view of a block support embodiment of the round bale support stand.

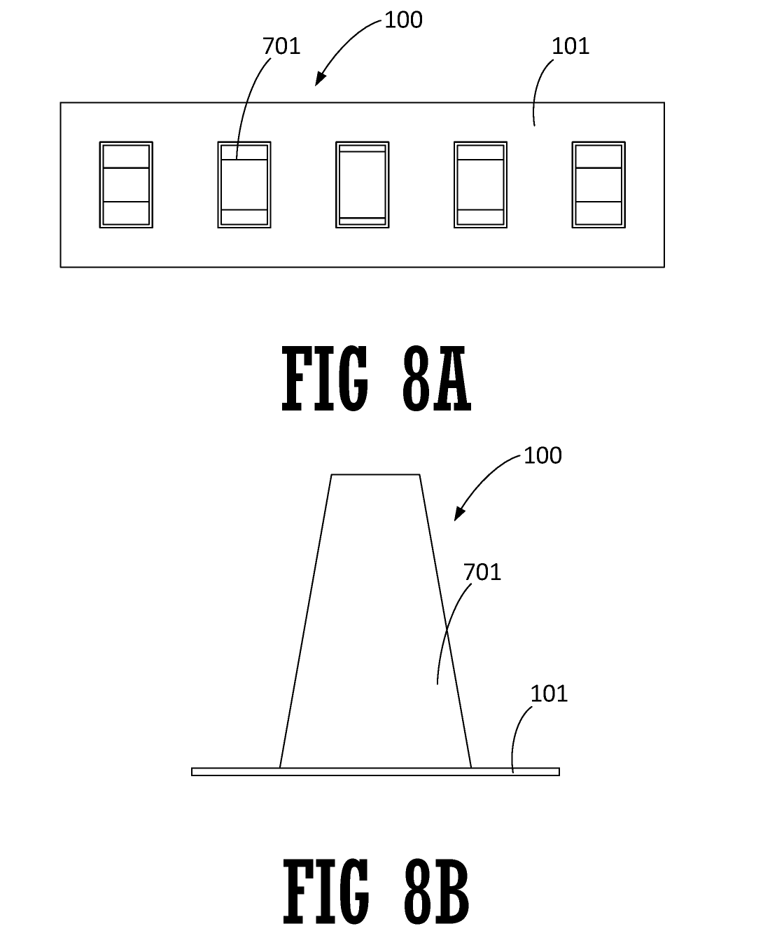

FIG. 9 is an isometric view of a 3× round extruded embodiment of the round bale support stand.

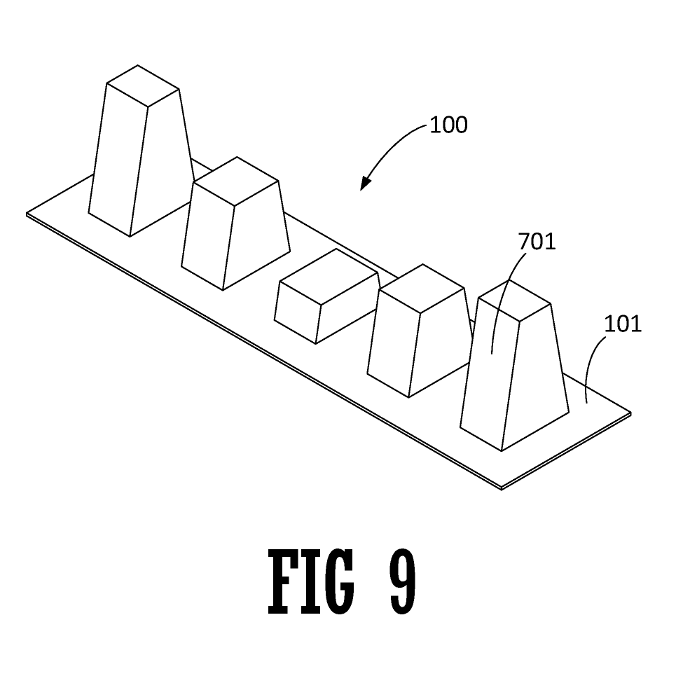

FIG. 10A is a front view of a 3× round extruded embodiment of the round bale support stand; FIG. 10B is a top view of a block support embodiment of the round bale support stand.

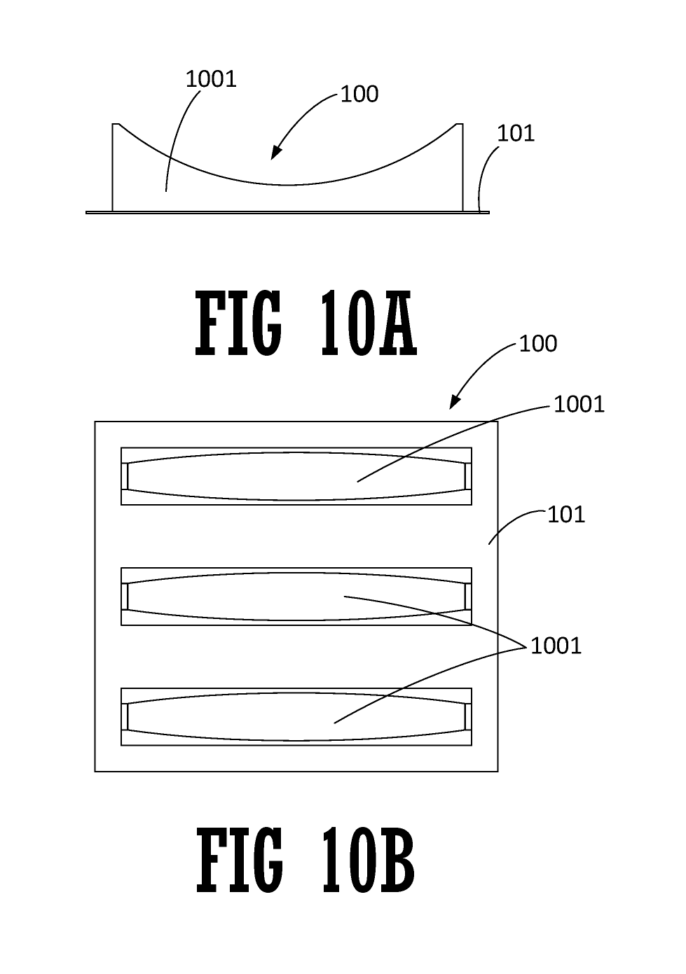

FIG. 11A is a bottom view of a 3× round extruded embodiment of the round bale support stand; FIG. 11B is a side view of a 3× round extruded embodiment of the round bale support stand.

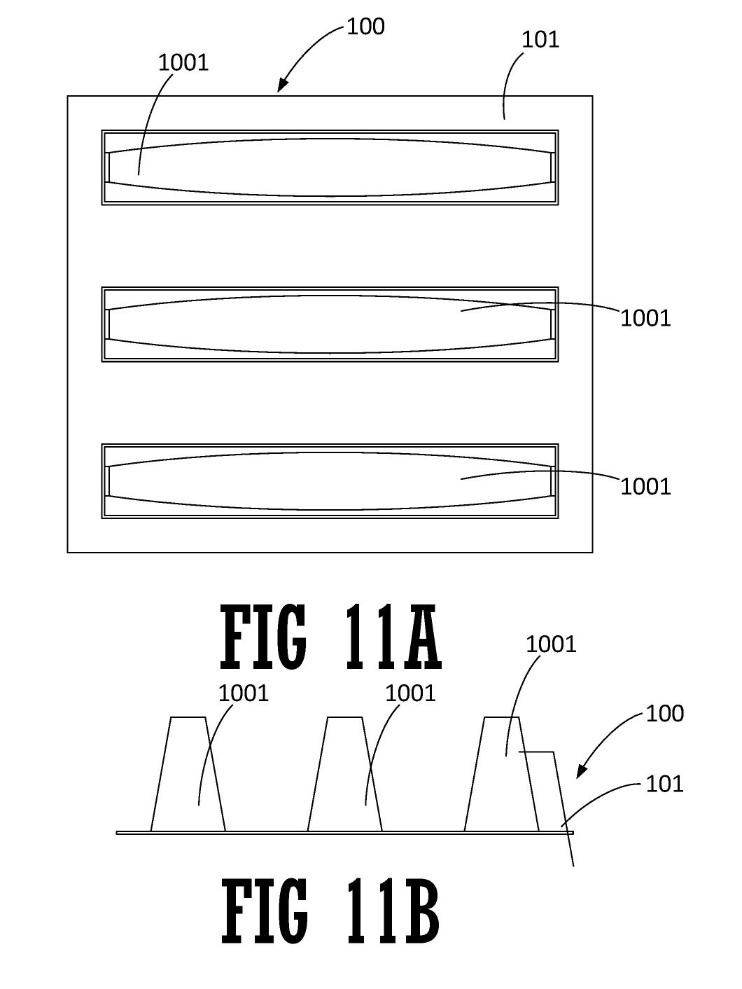

FIG. 12 is an isometric view of a 3× round extruded embodiment of the round bale support stand.

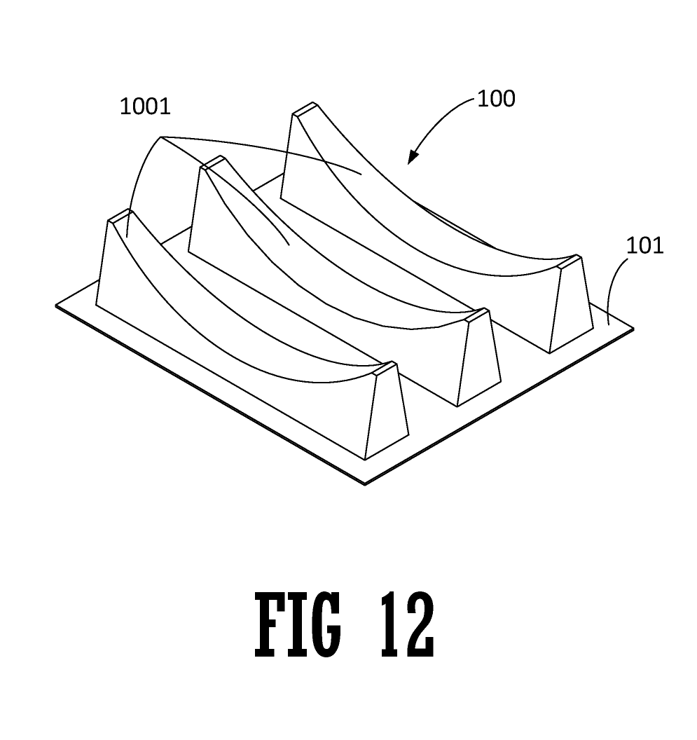

FIG. 13A is a front view of a 3× block supports embodiment of the round bale support stand; FIG. 13B is a top view of a 3× block supports embodiment of the round bale support stand.

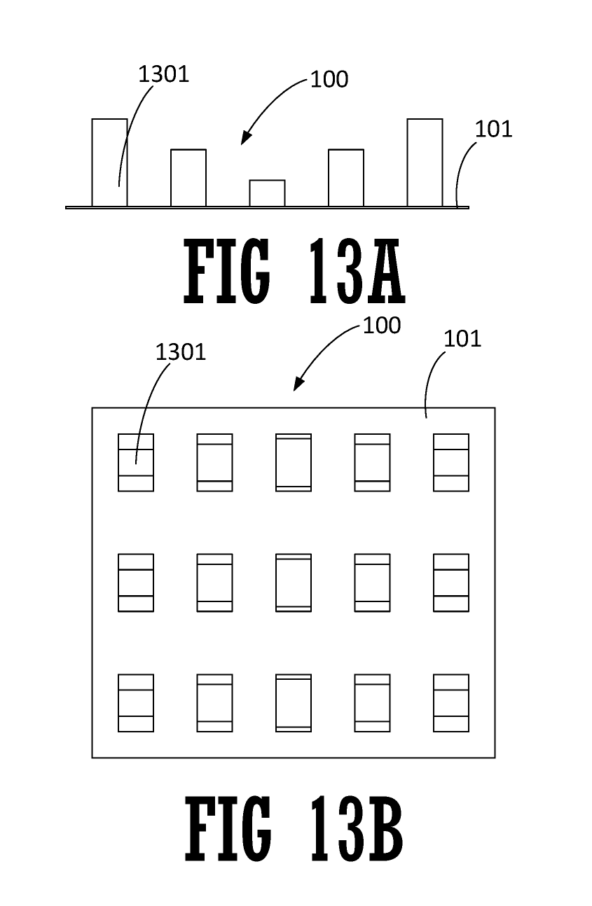

FIG. 14A is a bottom view of a 3× block supports embodiment of the round bale support stand; FIG. 14B is a side view of a 3× block supports embodiment of the round bale support stand.

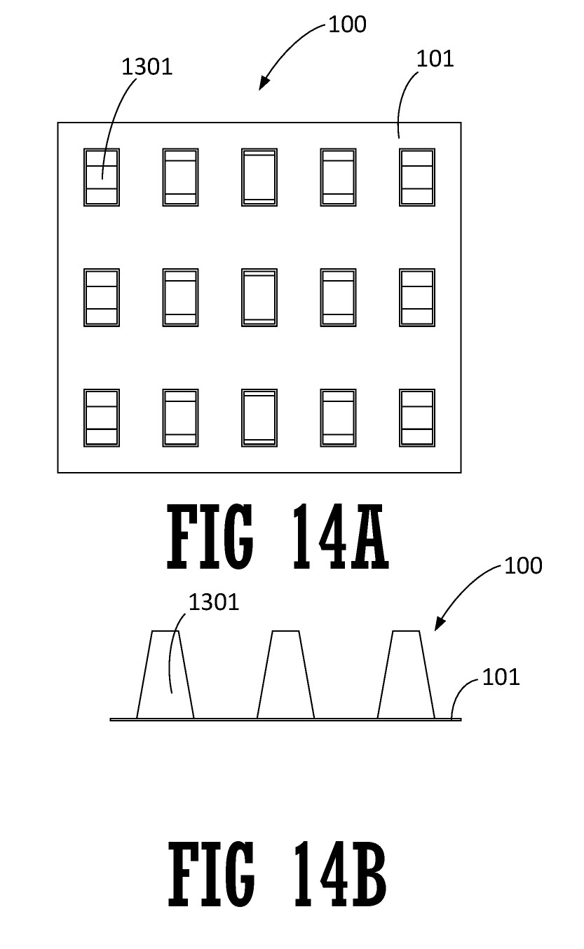

FIG. 15 is an isometric view of a 3× block supports embodiment of the round bale support stand.

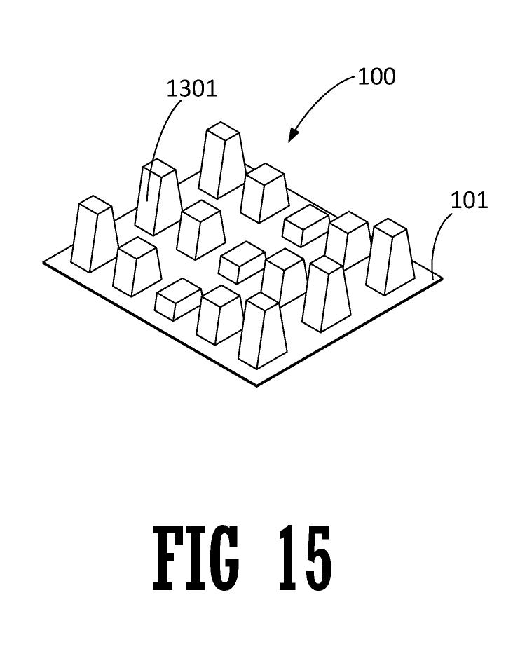

FIG. 16A is a front view of a continuous design embodiment of the round bale support stand; FIG. 16B is a top view of a continuous design embodiment of the round bale support stand.

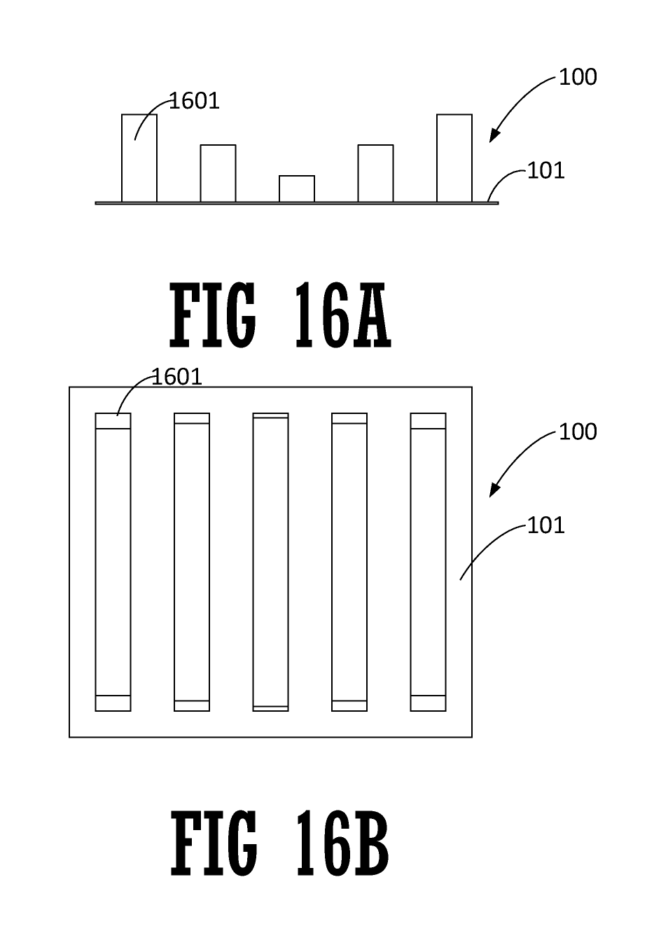

FIG. 17 is a side view of a continuous design embodiment of the round bale support stand.

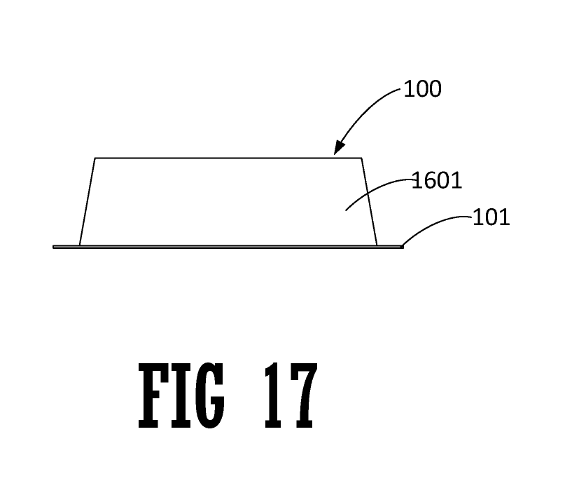

FIG. 18 is an isometric view of a continuous design embodiment of the round bale support stand.

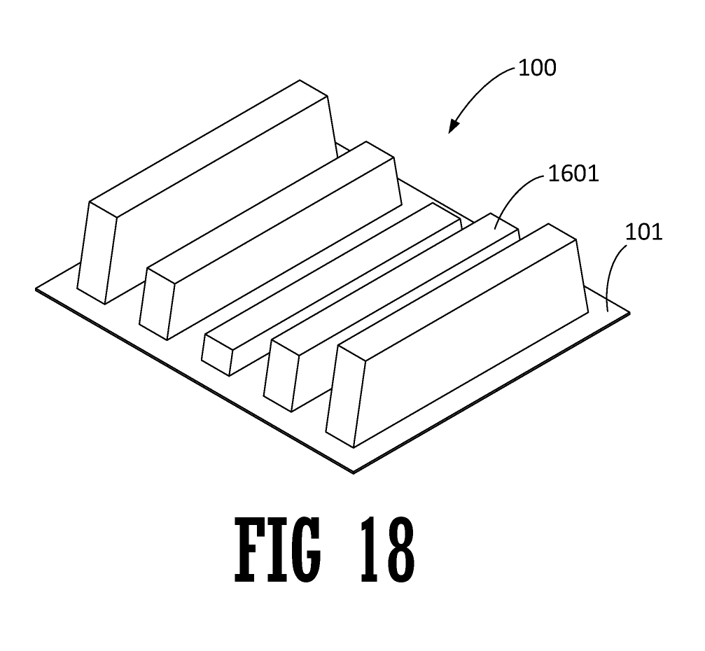

FIG. 19A is a front view of a sawtooth block embodiment of the round bale support stand; FIG. 19B is a top view of a sawtooth block embodiment of the round bale support stand.

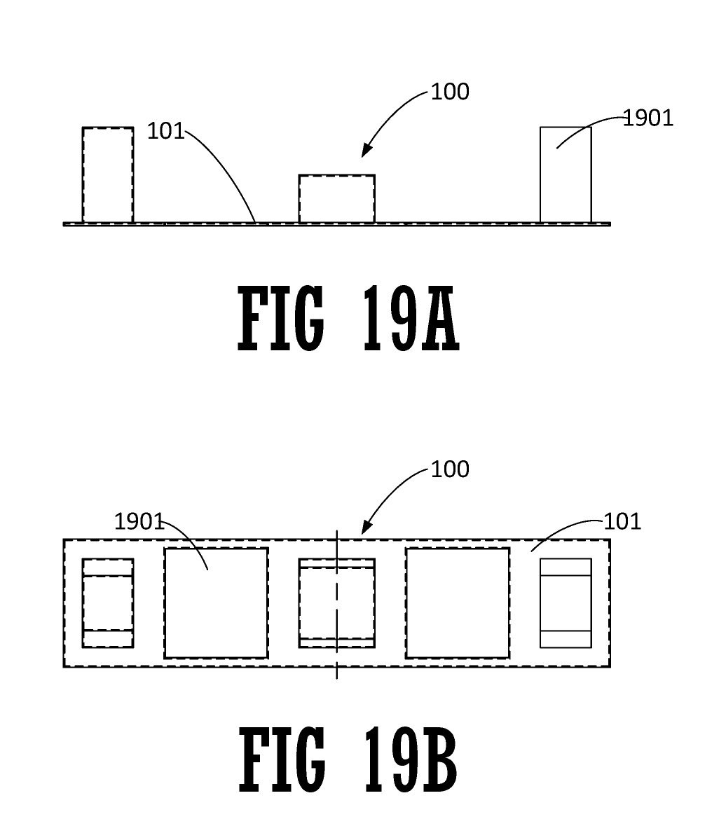

FIG. 20 is a side view of a sawtooth block embodiment of the round bale support stand.

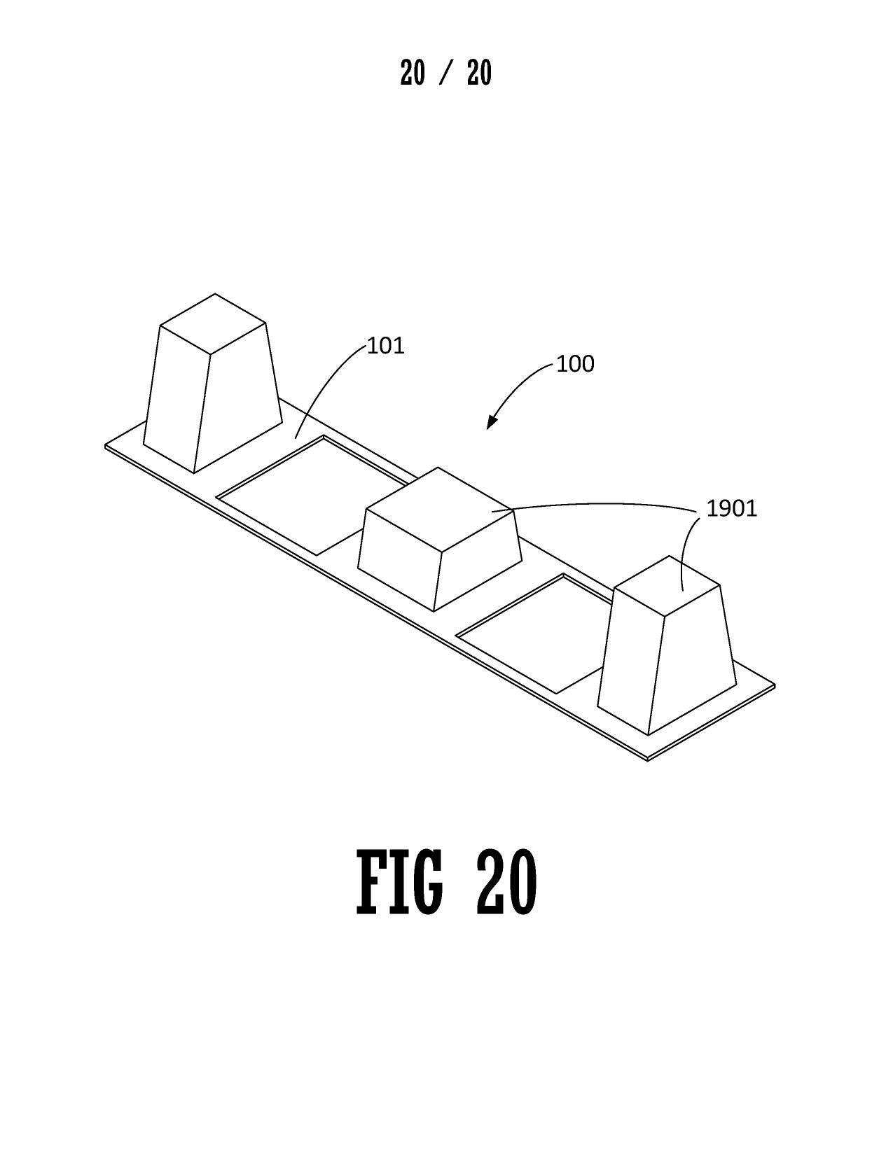

### DETAILED DESCRIPTION OF THE PREFERRED EMBODIMENTS

A preferred embodiment of the Round Bale Support Stand 100 comprises a stand base 101 and a bale support. The bale support is comprised of a support chosen from one of the following geometrical configurations:

i) a single curved support 102,

ii) a triangular support 401,

iii) a staggered block support 701,

iv) a set of curved supports 1001,

v) a set of staggered block supports 1301,

vi) a set of staggered parallel planks 1601, or

vii) a set of a sawtooth blocks 701.

The stand base is essentially a flat piece of material manufactured from wood, polymer, or metal that provides support to the Round Bale Support Stand when placed on the ground. The various bale support configurations are also manufactured from wood, polymer, or metal.

The single curved support 102 is comprised of a single curved support that is used to cradle the round bale. The single curved support 102 is essentially upwardly concave structure with a radius slightly larger than one-half the length of the base. The single curved support 102 is affixed to the stand base 101 to form an embodiment of the Round Bale Support Stand 100.

The triangular support 103 is comprised of a single triangular shaped support that is used to cradle the round bale. The triangular support 103 is a triangular structure or “V” that can accept a round bale from above. The triangular support 103 is affixed to the stand base 101 to form an embodiment of the Round Bale Support Stand 100.

The staggered block support 104 is comprised of a multiple block or rectangular supports with the lowest block located at the center of the multiple block arrangement and the tallest block located at the end of the multiple block arrangement. This arrangement of the multiple blocks allows the round bale to be cradled from above. The staggered block support 104 forms a progression of blocks that into a triangular arrangement that accepts a round bale from above. The staggered block support 104 is affixed to the stand base 101 to form an embodiment of the Round Bale Support Stand 100.

The set of curved supports 105 is comprised of two or more curved supports 105. Each curved support is comprised of a single curved support that is used to cradle the round bale. Each single curved support 105 is essentially upwardly concave structure with a radius slightly larger than one-half the length of the base. Each single curved support 105 is affixed to the stand base 101 to form an embodiment of the Round Bale Support Stand 100.

The a set of staggered block supports 106 is comprised of two or more rows each comprised of multiple block or rectangular supports with the lowest block located at the center of the multiple block arrangement and the tallest block located at the end of the multiple block arrangement. This arrangement of the multiple blocks allows the round bale to be cradled from above. The staggered block supports 106 forms a progression of blocks that into a triangular arrangement that accepts a round bale from above. The staggered block supports 106 is affixed to the stand base 101 to form an embodiment of the Round Bale Support Stand 100.

The set of staggered parallel planks 107 are comprised of two or more rows each comprised of long staggered raised planks with the heights of the planks increasing as the edge of the Round Bale Support Stand 100 is approached. This arrangement of the parallel planks 107 allows the round bale to be cradled from above. The parallel planks 107 are affixed to the stand base 101 to form an embodiment of the Round Bale Support Stand 100.

What is claimed is:

1. A device providing support for a round bale of hay that elevates the bottom surface above the ground preventing ground contact thereby eliminating ground rot of the bale due to moisture.

2. The device according to claim 1 wherein the support structure is made of plastic.

3. The device according to claim 1 wherein the support structure is made of wood.

4. The device according to claim 1 wherein the support structure is made of steel.

5. The device according to claim 1 wherein the support structure is made of concrete.

6. The device according to claim 1 wherein the support structure is made of a composite of wood, plastic, concrete or steel.

7. The device according to claim 1 wherein the support structure is a single curved support.

8. The device according to claim 1 wherein the support structure is a triangular support.

9. The device according to claim 1 wherein the support structure is a staggered block support.

10. The device according to claim 1 wherein the support structure is a plurality of curved supports.

11. The device according to claim 1 wherein the support structure is a set of staggered block supports.

12. The device according to claim 1 wherein the support structure is a set of staggered parallel planks.

13. The device according to claim 1 wherein the support structure is a set of sawtooth blocks.

14. A device providing support for a round bale of hay where the support cradle is in the form of an arc conforming to the bottom surface of the bale.

15. The device according to claim 14 wherein the support structure is made of plastic.

16. The device according to claim 14 wherein the support structure is made of wood.

17. The device according to claim 14 wherein the support structure is made of steel.

18. The device according to claim 14 wherein the support structure is made of concrete.

19. The device according to claim 14 wherein the support structure is made of a composite of wood, plastic, concrete or steel.
